(19) United States
(12) Patent Application Publication
(10) Pub. No.: US 2018/0090773 A1
(43) Pub. Date: Mar. 29, 2018

(54) FUEL CELL STACK

(71) Applicant: MITSUBISHI JIDOSHA KOGYO KABUSHIKI KAISHA, Tokyo (JP)

(72) Inventors: Yusuke HIRAMITSU, Tokyo (JP); Keisuke TASHIRO, Tokyo (JP)

(73) Assignee: MITSUBISHI JIDOSHA KOGYO KABUSHIKI KAISHA, Tokyo (JP)

(21) Appl. No.: 15/717,269

(22) Filed: Sep. 27, 2017

(30) Foreign Application Priority Data
Sep. 28, 2016 (JP) 2016-190174

(51) Int. Cl. H01M 8/04; H01M 8/24; H01M 8/0247

(52) U.S. Cl. CPC H01M 8/04; H01M 8/0247; H01M 8/2459

(57) ABSTRACT

A fuel cell stack has a stack of cells and separators interposed between the cells. Each cell has an electrolyte membrane, an anode provided on one side of the electrolyte membrane, and a cathode provided on another side of the electrolyte membrane. The separators include a metal separator provided on an outer side of the anode and a resin separator provided on an outer side of the cathode.

### CROSS-REFERENCE TO RELATED APPLICATION

The present application claims priority from Japanese Patent Application No. 2016-190174 filed on Sep. 28, 2016, the entire content of which is incorporated herein by reference.

### FIELD OF INVENTION

The present invention relates to a fuel cell stack having a stack of cells for generating electric power through a reaction of hydrogen and oxygen.

### RELATED ART

Related art cells include a polymer electrolyte fuel cell configured to generate electromotive force through an electrochemical reaction of hydrogen-containing fuel gas supplied to an anode (a fuel electrode) and oxygen-containing oxidizing gas (e.g., air) supplied to a cathode (an oxidant electrode). The fuel cell has a fuel cell stack in which cells are stacked with separators being interposed therebetween, each cell having a solid polymer membrane serving as an electrolyte membrane between the anode and the cathode. Each of the cathode and the anode includes a catalyst layer and a gas diffusion layer. The fuel cell stack is generally configured by stacking a separator, a gas diffusion layer, a catalyst layer, an electrolyte membrane, a catalyst layer, a gas diffusion layer and another separator in this order.

In each cell, electric power is generated by an electrochemical reaction in which hydrogen is decomposed into hydrogen ions and electrons by supplying fuel gas containing hydrogen to the anode, oxygen receives electrons and oxygen ions are generated by supplying oxidizing gas containing oxygen to the cathode, and water is generated from the hydrogen ions and oxygen ions.

The separators disposed between the cells have a function of separating the gases, serving as current collectors for electrically connecting the adjacent cells, serving as cell structure members, and providing paths for supplying the gases introduced from the outside of the system to the gas diffusion layers and for discharging surplus gases and generated water to the outside of the system. That is, the separators are required to have gas impermeability, heat conductivity, low impurity elution, strength, conductivity, and durability. As the separators, metal separators made by press-forming a sheet of metal, such as stainless steel or titanium, have been used in many cases.

However, a metal separator may be insufficient in corrosion resistance depending on the voltage condition of the fuel cell. For example, in a case where voltage of the fuel cell is relatively high, the separator is easily corroded due to the high voltage.

In recent years, to solve the problem described above, resin separators made of electrically conductive resin containing an electrically conductive material, such as carbon, have been developed and put into practical use. For example, a related art resin separator is configured as a separator provided on each side of a cell, and is made of a carbon-based electrically conductive material, such as graphite, and a resin material (see, e.g., JP2007-128815A).

Resin separators are superior to metal separators in corrosion resistance but lower in strength (toughness) as compared with metal separators. Further, resin separators may become brittle when a content ratio of electrically conductive material, such as carbon, is raised. Hence, when the resin separators are provided on both sides of each cell, a fuel cell stack in which the cells are stacked may be easily broken.

### SUMMARY

Illustrative aspects of the present invention provide a fuel cell stack in which an occurrence of breakage is suppressed.

According to an illustrative aspect of the present invention, a fuel cell stack has a stack of cells and separators interposed between the cells. Each cell has an electrolyte membrane, an anode provided on one side of the electrolyte membrane, and a cathode provided on another side of the electrolyte membrane. The separators include an anode-side separator provided on an outer side of the anode and a cathode-side separator provided on an outer side of the cathode. The anode-side separator is a metal separator made of a metal material, and the cathode-side separator is a resin separator made of a resin material.

### BRIEF DESCRIPTION OF THE DRAWINGS

FIG. 1 is a cross-sectional view illustrating a schematic configuration of a fuel cell stack according to an embodiment of the present invention;

FIG. 2 is a cross-sectional view illustrating a schematic configuration of a fuel cell stack according to another embodiment of the present invention; and

FIG. 3 is a cross-sectional view illustrating a schematic configuration of a fuel cell stack according to another embodiment of the present invention.

### DETAILED DESCRIPTION

Hereinafter, embodiments of the present invention will be described in detail with reference to the drawings.

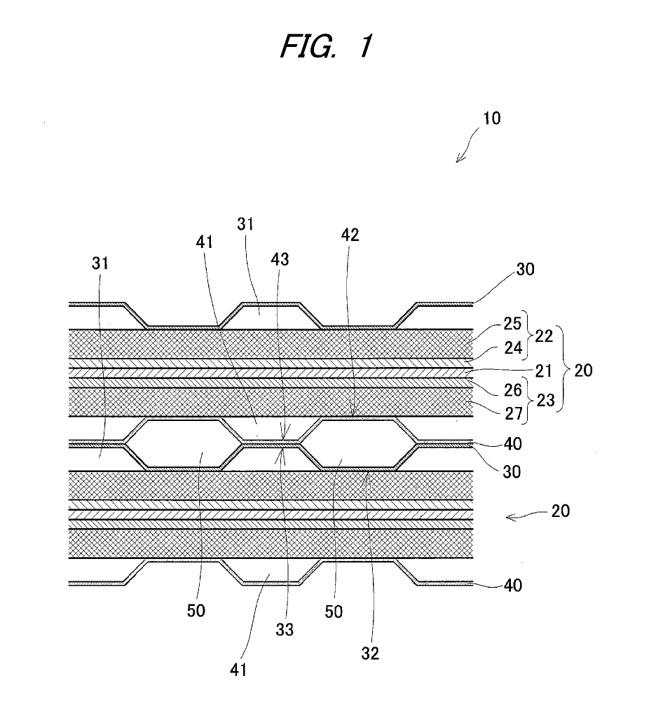

As shown in FIG. 1, a fuel cell stack 10 according to an embodiment of the present invention has a stack of cells 20 and is configured as, for example, a polymer electrolyte fuel cell. The number of the cells 20 forming the fuel cell stack 10 is not particularly limited, and may be determined as appropriate. FIG. 1 shows two cells 20 as part of the fuel cell stack 10.

Each cell 20 has an electrolyte membrane 21 (e.g., a solid polymer electrolyte membrane), an anode 22 serving as a fuel electrode on one side of the electrolyte membrane 21, and a cathode 23 serving an oxidant electrode on the other side of the electrolyte membrane 21. In other words, the anode 22 and the cathode 23 are provided so as to hold the electrolyte membrane 21 between the anode 22 and the cathode 23.

The anode 22 has an electrode catalyst layer 24 (anode-side catalyst layer) contacting the electrolyte membrane 21 and a gas diffusion layer 25 (anode-side gas diffusion layer) provided on the outer side of the electrode catalyst layer 24 (on the side opposite to the electrolyte membrane 21). The cathode 23 has an electrode catalyst layer 26 (cathode-side catalyst layer) contacting the electrolyte membrane 21 and a gas diffusion layer 27 (cathode-side gas diffusion layer) provided on the outer side of the electrode catalyst layer 26.

The electrolyte membrane 21 may be a generally available electrolyte membrane, examples of which including a fluorine electrolyte membrane, such as a perfluorocarbon sulfonic acid resin typified by Nafion (trademark), and a hydrocarbon-based electrolyte membrane obtainable by introducing an ion exchange group, such as a sulfonic acid group, a phosphate group or a carboxyl group, into a hydrocarbon-based resin, such as polyether ketone, polyether ether ketone or polyether sulfone.

The electrode catalyst layers 24, 26 contain electrode catalysts having catalytic activity for the electrode reactions at the anode 22 and the cathode 23 and also contain electrolytic materials. As the electrode catalyst, a catalyst in which a catalyst component is carried by electrically conductive particles is usually used. The catalyst component is not limited particularly, provided that the catalyst component has catalytic activity for the oxidation reaction of the fuel at the anode 22 (fuel electrode) or the reduction reaction of the oxidant at the cathode 23 (oxidant electrode), whereby a catalyst component generally used for polymer fuel batteries can be used. For example, platinum or an alloy of metal, such as ruthenium, iron, nickel, manganese, cobalt or copper, and platinum can be taken as an example of the catalyst component. As electrically conductive particles serving as the catalyst carrier, carbon particles, such as carbon black, an electrically conductive carbon material, such as carbon fiber, or a metal material, such as metal particles or metal fiber, can also be used.

Furthermore, a gas diffusion electrode base material, such as carbon fiber, is used for the gas diffusion layers 25, 27. The gas diffusion layers 25, 27 are required to have high gas diffusivity for diffusing fuel gas containing hydrogen supplied to the anode 22 or oxidizing gas containing oxygen supplied to the cathode 23 toward the electrode catalyst layers 24 and 25, high draining property for draining water generated by the electrochemical reaction to the outside of the system, and high conductivity for taking out the generated current. Gas diffusion electrode base materials being used usually can be used, provided that they have these functions.

On the outer sides of the cells 20, an anode-side separator 30 and a cathode-side separator 40 are provided as separators for shutting off the fuel gas and the oxidizing gas and for electrically connecting the cells 20.

The anode-side separator 30 is disposed on the outer side of the anode 22. Fuel gas supply paths 31 through which the fuel gas containing hydrogen is supplied are formed between the anode-side separator 30 and the anode 22. More specifically, the anode-side separator 30 has convex sections 32 contacting the surface of the gas diffusion layer 25 and has concave sections 33 disposed away from the surface of the gas diffusion layer 25 so as to form spaces serving as the fuel gas supply paths 31 between the surface and the separator. The convex sections 32 and the concave sections 33 are provided alternately and repeatedly.

The anode-side separator 30 is a metal separator, and is formed by, for example, forming a metal plate made of stainless steel or titanium in a shape of a corrugated plate. The plurality of fuel gas supply paths 31 is formed at predetermined intervals between the anode-side separator 30 serving as a metal separator and the anode 22. The oxidizing gas (hydrogen) supplied to the respective fuel gas supply paths 31 is diffused by the gas diffusion layer 25 as described above and then fed to the electrode catalyst layer 24.

The cathode-side separator 40 is disposed on the outer side of the cathode 23. Oxidizing gas supply paths 41 through which the oxidizing gas (e.g., air) containing oxygen is supplied are formed between the cathode-side separator 40 and the cathode 23. More specifically, the cathode-side separator 40 has convex sections 42 contacting the surface of the gas diffusion layer 27 and has concave sections 43 disposed away from the surface of the gas diffusion layer 27 so as to form spaces serving as the oxidizing gas supply paths 41 between the surface and the separator. The convex sections 42 and the concave sections 43 are provided alternately and repeatedly.

Like the anode-side separator 30, the cathode-side separator 40 has a shape of a corrugated plate. The plurality of oxidizing gas supply paths 41 is formed at predetermined intervals between the cathode-side separator 40 and the cathode 23. However, unlike the anode-side separator 30 serving as a metal separator, the cathode-side separator 40 is a resin separator made of an electrically conductive material, such as carbon, and a resin material. Since the separator is electrically conductive, it is not necessary to additionally provide a power collecting structure, whereby the configuration of the fuel cell stack can be made simple. The resin separator itself may be an existing separator, and its detailed description will be omitted here.

The fuel cell stack 10 is formed by stacking a plurality of joined units, each joined unit being provided by joining the anode-side separator 30 and the cathode-side separator 40 to respective sides of each cell 20.

When the cells 20 are stacked, the convex sections 32 of the anode-side separator 30 and the convex sections 42 of the cathode-side separator 40 being joined to the respective cells 20 are joined to each other, whereby cooling water supply paths 50 through which cooling water for cooling the respective cells 20 is supplied are formed between the anode-side separator 30 and the cathode-side separator 40. In other words, since the concave sections 33 of the anode-side separator 30 are joined to the concave sections 43 of the cathode-side separator 40, spaces serving as the cooling water supply paths 50 are formed between the convex sections 32 of the anode-side separator 30 and the convex section 42 of the separator 40.

As described above, the cathode-side separator 40, at which voltage becomes high, is a resin separator, so that a corrosion of the cathode-side separator 40 is suppressed (the corrosion resistance is improved). On the other hand, the anode-side separator 30, at which voltage does not become high, is a metal separator, so that the strength is improved without deteriorating the corrosion resistance. Consequently, the strength of the fuel cell stack 10 is also improved, and an occurrence of breakage of the fuel cell stack 10 is effectively suppressed.

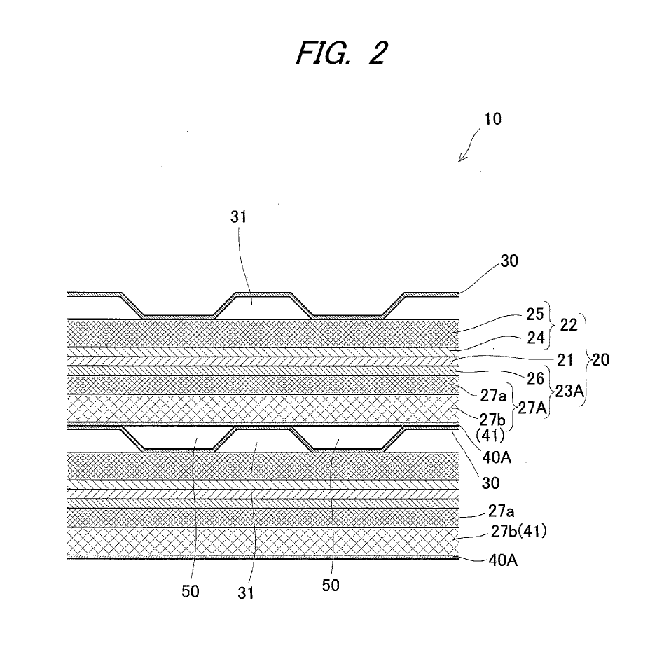

FIG. 2 is a cross-sectional view of a fuel cell stack according to another embodiment of the present invention, illustrating a schematic configuration of the fuel cell stack. The same or similar features as those of the foregoing embodiment are denoted by the same reference signs and repetitive description thereof will be omitted.

In this embodiment, a gas diffusion layer 27A of a cathode 23A of each cell 20 is configured to serve as an oxidizing gas supply path 41. More specifically, as shown in FIG. 2, the cathode 23A of each cell 20 has a gas diffusion layer 27A having two layers. That is, the gas diffusion layer 27A has a first diffusion layer 27a provided to contact the electrode catalyst layer 26 and a second diffusion layer 27b provided to contact the first diffusion layer 27a on a side opposite to the electrode catalyst layer 26.

A cathode-side separator 40A is joined to the surface of the second diffusion layer 27b. While the cathode-side separator 40 of the embodiment of FIG. 1 has a shape of a corrugated plate, the cathode-side separator 40A according to this embodiment has a shape of a flat plate.

The porosity of the second diffusion layer 27b is higher than that of the first diffusion layer 27a and is also higher than the porosity of the gas diffusion layer 25 of the anode 22. The porosity of the gas diffusion layer 25 of the anode 22 is, for example, about the same as the porosity of the first diffusion layer 27a.

The second diffusion layer 27b also serves as the oxidizing gas supply path 41. In other words, the second diffusion layer 27b is formed to have a porosity that is capable of supplying the oxidizing gas. As a result, the porosity of the second diffusion layer 27b is higher than the porosity of the first diffusion layer 27a.

Consequently, in the configuration of this embodiment, the oxidizing gas can be suitably supplied from the second diffusion layer 27b to the cathode 23, even with the cathode-side separator 40A having a shape of a flat plate.

Also in the configuration of this embodiment, the anode-side separator 30 is a metal separator, and the cathode-side separator 40A is a resin separator. Hence, as in the embodiment shown in FIG. 1, the strength of the fuel cell stack 10 is improved, and the occurrence of breakage of the fuel cell stack 10 is effectively suppressed. Further, in this embodiment, the manufacturing cost can be reduced because the cathode-side separator 40A is formed as a flat plate. The cathode-side separator 40 having a corrugated structure is formed by press processing, but because the cathode-side separator 40A is a resin separator, the time required for the processing is long and the manufacturing cost can easily become high. However, with this embodiment in which the cathode-side separator 40A is formed as a flat plate, the processing cost can be saved remarkably, and the fuel cell stack 10 can be manufactured at relatively low cost. Moreover, the fuel cell stack 10 can be made smaller and lighter.

While the cathode 23A having the gas diffusion layer 27A composed of two layers his been described as an example, the gas diffusion layer 27A is not necessarily required to be composed of two layers, and may be composed of a single layer. In the case of the gas diffusion layer 27A being composed of a single layer, the first diffusion layer 27a has higher porosity than the gas diffusion layer 25 of the anode 22, the porosity that is capable of supplying the oxidizing gas. The gas diffusion layer 27A may be composed of three or more layers.

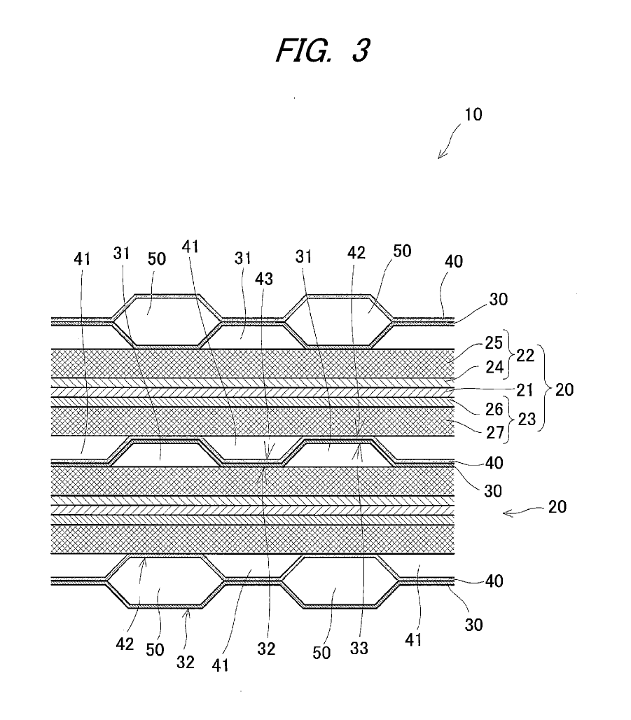

FIG. 3 is a cross-sectional view of a fuel cell stack according to another embodiment of the present invention, illustrating a schematic configuration of the fuel cell stack. The same or similar features as those of the embodiment of FIG. 1 are denoted by the same reference signs and repetitive description thereof will be omitted.

In this embodiment, the cooling water supply paths 50 to be formed between the cells 20 are partially omitted to make the fuel cell stack 10 smaller. More specifically, as shown in FIG. 3, on one side of each cell 20, the convex sections 32 of the anode-side separator 30 are joined to the convex sections 42 of the cathode-side separator 40 as in the embodiment shown in FIG. 1, whereby the plurality of cooling water supply paths 50 is formed between the anode-side separator 30 and the cathode-side separator 40.

On the other side of each cell 20 (on the side opposite to the cooling water supply paths 50), the convex sections 32 of the anode-side separator 30 are joined to the concave sections 43 of the cathode-side separator 40. That is, on the other side of each cell 20, the anode-side separator 30 and the cathode-side separator 40 are substantially integrated. Hence, the cooling water supply paths 50 are not formed between the anode-side separator 30 and the cathode-side separator 40, and the fuel gas supply paths 31 and the oxidizing gas supply paths 41 are provided alternately side by side.

Also with the configuration of this embodiment described above, the anode-side separator 30 is a metal separator, and the cathode-side separator 40 is a resin separator. Hence, the strength of the fuel cell stack 10 is improved, and the occurrence of breakage of the fuel cell stack 10 can be effectively suppressed. Further, in this embodiment, the cooling water supply paths 50 are omitted on the other side of each cell 20, and the anode-side separator 30 and the cathode-side separator 40 are integrated, whereby the thickness of the fuel cell stack 10 can be reduced and the fuel cell can be made smaller.

Even in a case where the cooling water supply paths 50 are partially omitted, cooling performance equivalent to that of the configuration (see FIG. 1) in which the cooling water supply paths 50 are not omitted can be ensured by increasing the supply amount of cooling water.

On the other side of each cell 20 (on the side opposite to the cooling water supply paths 50), the anode-side separator 30 and the cathode-side separator 40 are integrated in an overlaid manner in the embodiment described above. However, instead of this integrated separator, only the cathode-side separator 40, a resin separator, may be provided.

While the present invention has been described with reference to certain embodiments thereof, the scope of the present invention is not limited to the embodiments described above, and it will be understood by those skilled in the art that various changes and modifications may be made therein without departing from the scope of the present invention as defined by the appended claims.

For example, while the resin separator made of an electrically conductive resin material is taken as an example in the embodiments described above, a resin material forming the resin separator may not be electrically conductive if a power collecting structure is additionally provided.

What is claimed is:

1. A fuel cell stack comprising:
a stack of cells; and
separators interposed between the cells,
wherein each cell comprises an electrolyte membrane, an anode provided on one side of the electrolyte membrane, and a cathode provided on another side of the electrolyte membrane,
wherein the separators comprise an anode-side separator provided on an outer side of the anode and a cathode-side separator provided on an outer side of the cathode, and
wherein the anode-side separator is a metal separator made of a metal material, and the cathode-side separator is a resin separator made of a resin material.

2. The fuel cell stack according to claim 1, wherein the cathode-side separator has a shape of a flat plate.

3. The fuel cell stack according to claim 2, wherein the anode comprises an anode-side catalyst layer provided in contact with the electrolyte membrane and an anode-side gas diffusion layer provided on an outer side of the anode-side catalyst layer,
wherein the cathode comprises a cathode-side catalyst layer provided in contact with the electrolyte membrane and a cathode-side gas diffusion layer provided on an outer side of the cathode-side catalyst layer, and
wherein a porosity of at least a portion of the cathode-side gas diffusion layer is higher than a porosity of the anode-side gas diffusion layer.

4. The fuel cell stack according to claim 3, wherein the cathode-side gas diffusion layer comprises a first diffusion layer provided in contact with the cathode-side catalyst layer and a second diffusion layer provided in contact with the first diffusion layer on a side opposite to the cathode-side catalyst layer, and
wherein a porosity of the second diffusion layer is higher than a porosity of the first diffusion layer.

5. The fuel cell stack according to claim 1, wherein the resin material is electrically conductive.

6. The fuel cell stack according to claim 2, wherein the resin material is electrically conductive.

7. The fuel cell stack according to claim 3, wherein the resin material is electrically conductive.

8. The fuel cell stack according to claim 4, wherein the resin material is electrically conductive.
